(19) United States
(12) Patent Application Publication
(10) Pub. No.: US 2008/0300755 A1
(43) Pub. Date: Dec. 4, 2008

(54) SIDE COLLISION AVOIDANCE SYSTEM

(76) Inventors: Dinu Petre Madau, Canton, MI (US); Behrouz Ashrafi, Northville, MI (US)

Correspondence Address: VISTEON/BRINKS HOFER GILSON & LIONE, 524 South Main Street, Suite 200, Ann Arbor, MI, 48104, US

(21) Appl. No.: 11/755,302

(22) Filed: May 30, 2007

(51) Int. Cl. G08G 1/16; G05D 3/00; G06F 17/00

(52) U.S. Cl. 701/49; 340/3.1; 701/301; 701/96

(57) ABSTRACT

A motor vehicle side collision avoidance system for avoiding collisions with objects. The system includes a direction sensor generating a direction signal corresponding a direction of motion of the vehicle, an external detector generating a detector signal corresponding to a location of objects outside of the vehicle, and a braking control system including at least two independently operable braking devices coupled to respective wheels. A processor is coupled to the direction sensor, the external detector, and the braking control system. The processor receives the direction and detector signals and is configured to send an avoidance signal to the braking control system based on the direction and detector signals. Upon receipt of the avoidance signal, the braking control system activates appropriate braking devices to avoid collision with the objects.

### BACKGROUND

1. Field of the Invention

The present invention generally relates to intelligent transportation systems. More specifically, the invention relates to collision avoidance systems for motor vehicles.

2. Description of Related Art

When a driver of a motor vehicle desires to change lanes, the driver ordinarily should first glance in an appropriate side view mirror to make sure the adjacent lane is clear. However, not all drivers take the time to look to see if the adjacent lane is clear. In addition, even if they do look, the view provided by a side view mirror is limited and may not show the entire lane adjacent to the motor vehicle. The portion of the adjacent lane not shown in the side view mirror is called a blind spot. To check the blind spot, the driver is required to turn their head and look over their shoulder, resulting in a potentially dangerous situation since it requires the driver to completely take their eyes off of the road ahead.

To minimize the need for the driver to monitor the adjacent lane, some vehicles have implemented warning systems. Such warning systems use an external detector and a processor and provide a warning signal to the driver to alert them to the presence of an object in the adjacent lane. However, existing systems rely on the driver taking corrective action after being warned to prevent possible collisions with the object in the adjacent lane. These systems do not account for those drivers who may not notice the warning signal or may attempt to change lanes despite the warning signal, possibly resulting in a side collision with the object.

In view of the above, it is apparent that there exists a need for an improved side collision avoidance system.

### SUMMARY

In satisfying the above need, as well as overcoming the enumerated drawbacks and other limitations of the related art, the present invention provides a side collision avoidance system. The system generally includes a direction sensor generating a direction signal corresponding to a change in direction of the vehicle, an external detector generating a detector signal corresponding to a location of objects outside of the vehicle, and a braking control system including at least two independently operable braking devices coupled to respective wheels of the motor vehicle. A processor disposed within the motor vehicle is coupled to the direction sensor, the external detector, and the braking control system. The processor receives the direction signal and the detector signal and, based thereon, is configured to send an avoidance signal to the stability control. Upon receipt of the avoidance signal, the braking control system activates appropriate braking devices to avoid objects.

In one embodiment, the braking control system is coupled to four independently operable braking devices. In another embodiment, the braking devices are attached to wheels on opposing sides of the vehicle. In a further embodiment, the braking control system directs the vehicle away from objects using “steering-by-braking”. Steering-by-braking involves the activation of braking devices on the side of the vehicle opposite of the location of the objects to be avoided.

In one aspect of the invention, the processor is configured to calculate blind spot boundaries for the motor vehicle, compare the blind spot boundaries to the location of objects around the vehicle, and send the avoidance signal to the braking control system if an object is located within the blind spot boundaries. A blind sport warning indicator may also be coupled to the processor and may provide an indication to a driver if an object is within the calculated blind spot boundaries. The warning indicator may be, for example, provided interiorly and/or exteriorly of the vehicle and may include a visual and/or an audible warning device.

In another aspect, the blind spot boundaries are calculated based upon fixed or variable parameters relating to motor vehicle geometry supplied to the processor. The variable parameters may, for example, be supplied to the processor by at least one movable side viewing device being attached to the vehicle and moveable between a first orientation and a second orientation. In this example, the side viewing device is coupled to at least one position sensor adapted to generate a position signal corresponding to the orientation of the side view device. The processor is coupled to the position sensor to receive the position signal. A modified position signal is generated by the position sensor upon movement of the side viewing device. The processor of this embodiment then calculates altered blind spot boundaries based upon the modified position signal and compares the altered blind spot boundaries to the detector signal. If an object is within the altered blind spot boundaries, the processor provides the indication to the driver and sends the avoidance signal to the braking control system if appropriate.

In an alternative embodiment, a seat sensor may be disposed within the vehicle and coupled to at least a driver's seat of the vehicle. The seat sensor generates a seat signal corresponding to the orientation of the driver's seat. In this embodiment, the processor is also coupled to the seat sensor and configured to read the seat signal. The processor calculates the blind spot boundaries based on both the position signal and the seat signal.

In yet another embodiment, the vehicle may include a driver height sensor that is configured to measure the height of the driver. The driver height sensor then generates a height signal corresponding to the height of the driver, and the processor reads the height signal. The processor then calculates the blind spot boundaries based on both the position signal and the height signal.

In still another embodiment, the invention includes both the driver height sensor and the seat sensor coupled to the processor, and the processor dynamically calculates the blind spot boundaries based on the position signal, the seat signal, and the height signal. As with the prior embodiment, the processor compares the blind spot boundaries to the detector signal and provides an indication, or warning signal, to a driver if an object is located within the calculated blind spot boundaries.

In the various embodiments of the present invention, the external detector may include at least one of a radar sensor, a ladar sensor, an ultrasonic sensor, and an optical sensor. The optical sensor may include a digital camera. The direction sensor may include, for example, one of an accelerometer, a steering sensor, and a navigation sensor. These sensors may be used singly or in various combinations depending on the application.

In a further aspect, the present invention encompasses a method for avoiding side collisions. The method includes monitoring from a direction sensor a direction signal corresponds to a direction of motion of the vehicle; monitoring from an external detector a detector signal corresponding to the a location of objects outside of the vehicle; comparing the direction signal to the detector signal; sending an avoidance signal to a braking control system if the direction signal indicates that the motor vehicle is heading toward the location at least one of the objects; and activating appropriate braking devices coupled to the braking control system to direct the vehicle away from the object.

In further embodiments, the system/method may include overriding the appropriate braking devices by additional steering or braking input from a driver of the vehicle. Also, the avoidance signal may optionally be sent to the braking control system only if the location of an object correspond to a blind spot of the vehicle.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic diagram of a side collision avoidance system for a motor vehicle;

FIG. 2 is a top view of a roadway showing three motor vehicles and various fields of view and the blind spot of a motor vehicle;

FIG. 3 is a top view, similar to FIG. 2, showing the side view mirror in a different orientation; and

FIG. 4 is a flow chart illustrating a method for avoiding objects.

### DETAILED DESCRIPTION

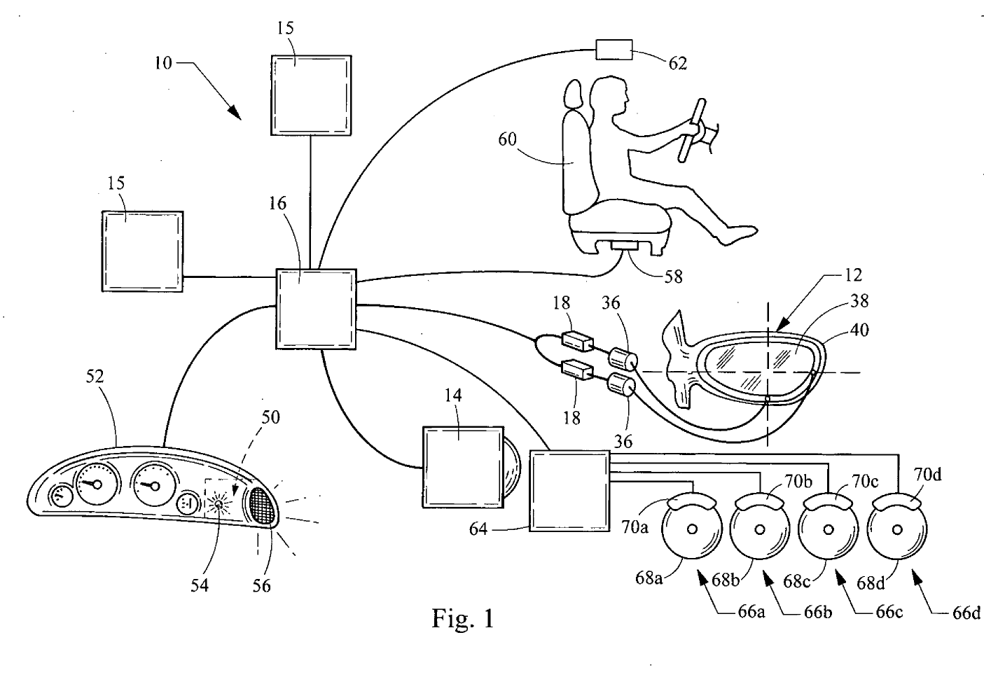

Referring now to FIG. 1, a side collision avoidance system embodying the principles of the present invention is illustrated therein and generally designated at 10. As its primary components, the side collision avoidance system 10 of a motor vehicle 11 includes an external detector 14, a direction sensor 15, and a braking control system 64. A processor 16 disposed within the motor vehicle 11 is coupled to the external detector 14, the direction sensor 15, and the braking control system 64.

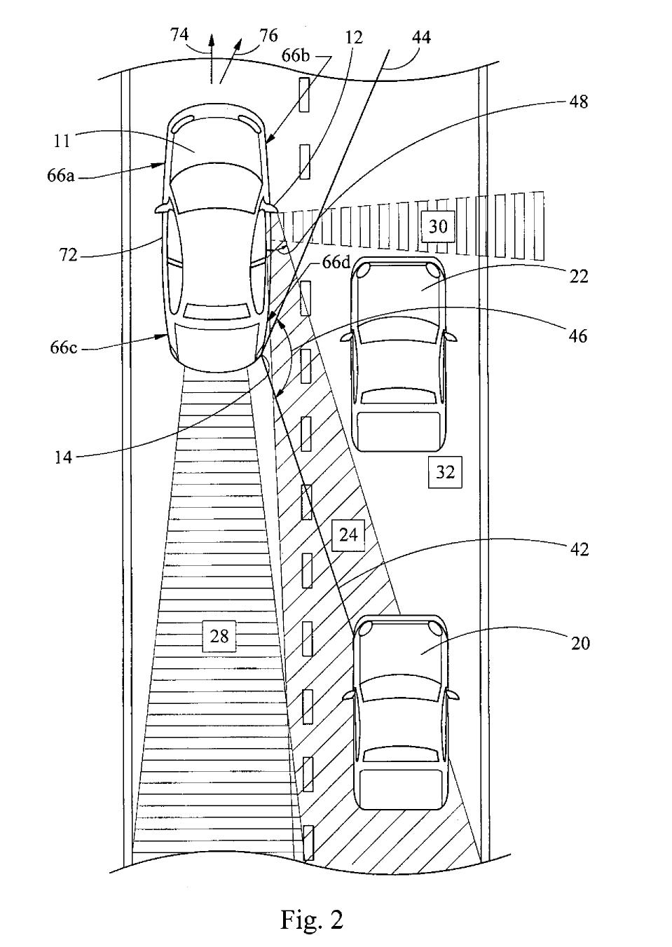

The external detector 14 is configured to generate a detector signal corresponding to a location of one or more objects, for example, a second and third motor vehicle 20 and 22 relative to the motor vehicle 11 (see FIG. 2). In doing this, the external detector 14 has a detector angle of view 46, defined between lines 42 and 44. As clearly shown in FIG. 2, both the second and third motor vehicles 20 and 22 of this example are encompassed by the angle of view 46.

The external detector 14 may be any non-contact device capable of remotely detecting objects including, but not limited to, radar sensors, ladar sensors, lidar sensors, ultrasonic sensors, and optical sensors. Radar sensors scan the angle of view 46 by transmitting radio waves throughout the angle of view 46. The radar sensor detects any radio waves reflected from the surfaces of the motor vehicles 20 and 22, or any other objects, and determines the position, velocity, and other characteristics of the detected objects by analyzing the reflected radio waves.

The ladar and lidar sensors are basically forms of laser radar. Ladar stands for “laser detection and ranging” and lidar stands for “light detection and ranging” and they may be used interchangeably with one another. These types of sensors use laser light to scan the angle of view 46 and analyze any reflected laser light to locate and characterize the objects. The lader or lidar sensor may use any appropriate form of light including, for example, ultraviolet, visible, or near infrared laser light.

The ultrasonic sensor operates similar to the radar and ladar sensors. However, rather than electromagnetic radiation, they use ultra high frequency sound waves to scan the angle of view 46. Any reflected sound waves are detected and analyzed to locate and characterize the objects.

An optical sensor operates differently from the other sensors discussed above since it is completely passive. The optical sensor may include at least one digital video camera that monitors the angle of view 46. When objects move into the angle of view 46, electronics included with the optical sensor analyze the images captured by the video camera and to identify the location and other characteristics of the objects. As above, this information is then converted by the electronics into a detector signal corresponding to the location of the objects.

The direction sensor 15 can be any device configured to generate a direction signal corresponding to a direction of motion of the vehicle 11. As best shown in FIG. 2, the direction signal generated by the direction sensor 15 may indicate the vehicle 11 is moving straight down the lane as indicated by the arrow 74. In this example, so long as the vehicle 11 is moving in the direction of the arrow 74, any risk of a collision with, for example, the third motor vehicle 22 is minimal. On the other hand, if a driver of the vehicle 11 initiates a lane change to the right, in the direction of the arrow 76, the direction signal will correspond to this direction change. When the vehicle 11 changes direction to that of the arrow 76, the risk of a collision with the third motor vehicle 22 increases.

The direction sensor 15 may be any appropriate device for determining the direction of motion of the motor vehicle 11. Some appropriate devices include accelerometers, gyroscopes, steering sensors, navigation sensors and visual sensors. It should be noted that the above devices are examples and any other appropriate devices may be used without falling beyond the scope and spirit of the present invention.

Accelerometers include any devices capable of registering a change in the acceleration of the vehicle 11. As the vehicle 11 is turned by the driver, the accelerometer experiences an acceleration having a particular direction. As a result, the accelerometer generates a signal proportional to the change in acceleration, and hence direction, of the motor vehicle.

Gyroscopes include devices having a rotating mass for measuring or maintaining orientation. A rotational axis of the rotating mass tends to have a fixed orientation independent of the orientation of the motor vehicle 11. Differences between the orientation of the rotational axis and that of the motor vehicle 11 are used to determine changes in direction of the motor vehicle 11 and generate the direction signal.

Steering sensors include any devices capable of registering a change in the steering input of the vehicle 11. For example, the steering sensor may include a potentiometer of other sensor coupled to the steering wheel of the motor vehicle. When the driver turns the steering wheel, a signal from the potentiometer will indicate the amount and direction the steering wheel is turned, resulting in a signal proportional to the change in the direction of motion of the vehicle 11.

Navigation sensors may include any devices capable of determining the direction of motion of the vehicle 11 based on external references including, but not limited to, satellites and cellular phone towers. The navigation sensors calculate the vehicle's direction and location by monitoring signals from the external references.

Visual sensors include cameras that, for example, monitor the boundaries of a road upon which the motor vehicle 11 travels. When the driver of the vehicle initiates a turn or lane change, the view of the boundaries monitored by the cameras changes. The amount of the change is proportional to the change in direction of the vehicle and may be used to generate the direction signal.

The braking control system 64 is disposed within the vehicle 11 and includes independently operable braking devices coupled to respective wheels of the vehicle 11. In the non-limiting example shown in FIG. 1, four braking devices 66a-66d are shown corresponding to the front-left, front-right, rear-left and rear-right wheels of a typical motor vehicle 11 (see FIG. 2). However, other applications may have differing numbers of braking devices and wheels.

The braking control system 64 is configured to operate each of the braking devices 66a-66d independently or in concert with one another. The braking devices 66a-66d may include, but are not limited to, disc brakes or drum brakes. In the example of FIG. 1, disc brakes are shown each respectively having a rotor 68a-68d and a caliper 70a-70d. When the braking control system 64 operates any one of the braking devices 66a-66d, the calipers apply compress to a brake pad (not shown) against the rotors 68a-68d, creating friction thereby slowing or stopping the rotation of the rotors 68a-68d, and hence the wheels (not shown), of the vehicle 11.

The braking control system 64 is further configured to influence the direction of travel of the vehicle 11 using steering-by-braking. Steering-by-braking involves applying one or more braking devices on a side of the vehicle 11 corresponding to a direction in which it is desired to turn the vehicle. In other words, to steer away from an object in the road requires operating braking devices on the side of the vehicle opposite from the object.

Steering-by-braking is best illustrated by way of the non-limiting example shown in FIG. 2. In this example, if the vehicle 11 is traveling generally in the direction indicated by the arrow 76, it may be desirable to direct the vehicle 11 back to the left to avoid a collision with the vehicle 22. This direction change may be accomplished through the braking control system 64 operating one or more of the braking devices 66a and 66c on a left side 72 of the vehicle 11. The amount of braking force necessary is related to how quickly the vehicle 11 needs to be turned with increasing force increasing the vehicle's turn rate. In some instances it may be desirable to override steering-by-braking using additional input from the driver through, for example, the steering wheel and/or applying the brakes.

Returning to FIG. 1, the processor 16 can be, for example, any conventional digital or analog device capable of monitoring input signals, performing calculations, comparing the signals, and initiating an appropriate response. In one embodiment, the processor 16 is a digital signal processor configured to continuously monitor the direction signal generated by the direction sensor 15 and the detector signal generated by the external detector 14. The processor 16 may also store various physical constants including, for example, those necessary to characterize the geometry of the motor vehicle 11. One example of such a constant includes, but is not limited to, a viewing angle 48 of a side view device 12 attached to the motor vehicle 11 (see FIG. 2).

The processor 16 is configured to analyze the direction signal for any changes in the direction of motion of the vehicle 11. The processor 16 is also configured to analyze the detector signal to determine the location of any objects with respect to the motor vehicle 11. The direction of motion is compared to the location of any objects with respect to the motor vehicle 11 and the processor may, for example, calculate a probability of a collision with any of the objects. If the probability exceeds a certain threshold, the processor is configured to send an avoidance signal to the braking control system. The avoidance signal is received by the braking control system 64, which is configured to initiate steering-by-braking to avoid the objects as described above.

It should be appreciated that the processor 16 is able to respond to any vehicle and traffic changes as they occur by continuously performing these calculations. Thus, the processor 16 dynamically adjusts to any changes in direction of the vehicle 11 or in traffic as they occur, allowing the avoidance system 10 to quickly respond to dynamically changing environments.

The present invention may be used as described above or in an alternate embodiment to supplement a blind spot warning system as shown in FIG. 1. If used to supplement a blind spot warning system, the processor 16 may also be configured to calculate blind spot boundaries and compare those boundaries to the location of objects outside of the vehicle. In this alternate embodiment, the avoidance signal may be sent, for example, if any detected objects are located within the blind spot boundaries. Conversely, even if there is a probability of a collision with the objects, but the objects are not located in a vehicle blind spot, then the avoidance signal may not be sent by the processor 16.

When used to supplement a blind spot warning system, an indication that the objects are located within the blind spot boundaries may be optionally provided to the driver. The indication to the driver may be provided by, for example, means of a warning indicator 50 coupled to the processor 16. The warning indicator 50 may, for example, be incorporated into an instrument cluster 52 of a vehicle instrument panel inside of the motor vehicle 11. The warning indicator 50 includes, but is not limited to, a visual warning signal 54, an audible warning signal 56 or a haptic warning device. The visual warning signal 54 may be a light or series of lights that indicate the presence, and optionally the location, of an object within the vehicle blind spot. In addition to, or in place of, the visual warning signal 54, a tone or other audible warning may be provided either through, for example, a dedicated speaker 56 as shown in FIG. 1 or through a vehicle audio system (not shown). In another instance, the indication may optionally be provided by an exterior indicator. For example, the reflecting member 38 of the side view device 12 may include lights, such as LED's, to warn the driver (not shown). In still other instances, the indication to the driver may be provided by both interior and exterior warning indicators.

Depending on the embodiment, the blind spot boundaries may be calculated based upon predetermined, fixed parameters relating to the geometry of the vehicle 11. In this case, the boundaries need only be calculated once before being stored by processor 16. Alternately, the blind spot boundaries may be dynamically calculated based upon one or more variable parameters. This latter situation allows the boundaries to reflect changes in the motor vehicle including, but not limited to, orientational changes to the side view device 12. As best shown in FIG. 2, the side view device 12 is configured to provide a driver of the motor vehicle 11 with a view of the area beside and to the rear of the motor vehicle 11. This is indicated by a first viewing area 24. As can be seen in this figure, the side view device 12 has a limited viewing angle 48. The side view device 12, therefore, only allows the driver to see objects within the first viewing area 24, for example, a second motor vehicle 20. A third motor vehicle 22, located in an area 32 outside of the first viewing area 24, a rear view area 28, and a driver's peripheral view 30, will not be visible to the driver. The area 32 in which the third motor vehicle 22 is not visible to the driver is the blind spot and is hereafter referred to as blind spot 32.

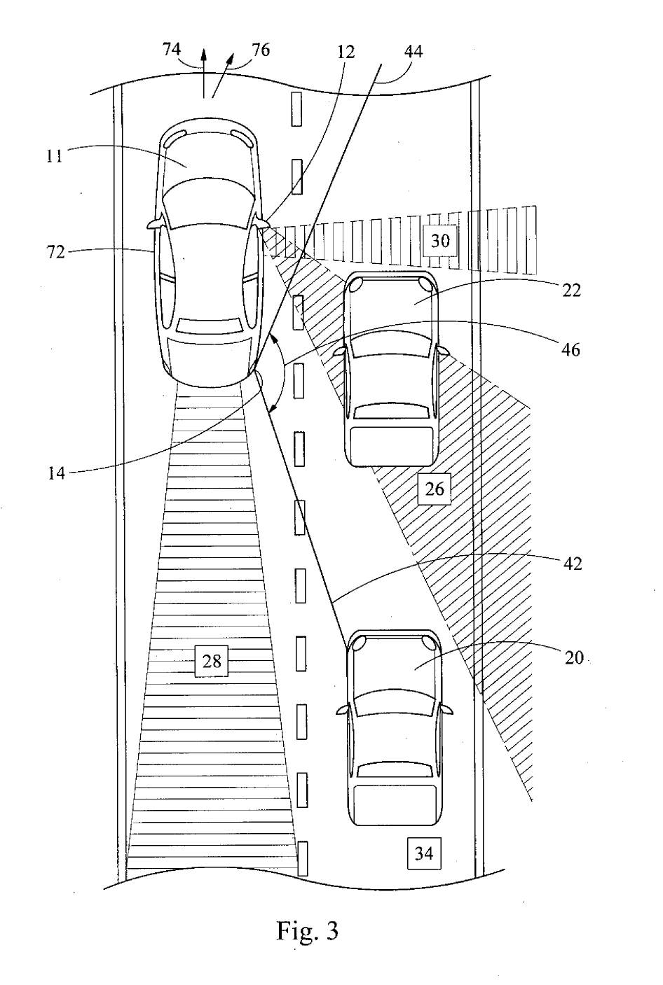

To check for objects in the first blind spot 32, the driver may choose to look over his or her shoulder or may choose to adjust the movable side view device 12 outward (relative to the vehicle 11). If the moveable side view device 12 is moved outward, a second viewing area 26, and hence the third motor vehicle 22, becomes visible to the driver. However, as can be seen, as shown in FIG. 3, a new blindspot, second blind spot 34, is thereby created where the second motor vehicle 20 is no longer visible to the driver.

Returning back to FIG. 1, a position sensor 18 is coupled to the side view device 12. The position sensor is configured to respond to the movement of the side view device 12, which may be adjusted manually or by electric motors 36 and generate a position signal corresponding to the orientation of the side view device 12. The position sensor 18 may be any conventional device known in the art including, but not limited to, potentiometers.

In this embodiment, the processor 16 is configured to also analyze the position signal to determine the orientation of the side view device 12. Once the orientation of the side view device 12 has been determined, that information is used by the processor 16, along with the viewing angle information and other stored characteristics, to continuously calculate the boundaries of the blind spot 32. The processor 16 then compares the locations of the objects with the calculated boundaries of the first blind spot 32 (see FIG. 2). If any objects are located within the boundaries of, for example, the first blind spot 32, the processor 16 is configured to provide an indication to the driver and, as noted above, send an avoidance signal to the braking control system 64, if necessary, to avoid potential collisions.

Turning to FIG. 3, when the side view device 12 is moved, for example, by the driver of the motor vehicle 11, an altered position signal is generated by the position sensor 18. The processor 16 then calculates an altered set of boundaries corresponding to, for example, the second blind spot 34. As above, the processor 16 compares the locations of the objects with the altered boundaries of the second blind spot 34. If any objects are located within the boundaries of the second blind spot 34, the processor 16 provides an indication to the driver and, if necessary, sends the avoidance signal.

In some embodiments, the side view device 12 may include a conventional side view mirror assembly. The side view mirror assembly may include a reflecting member 38 movably disposed within a stationary housing 40. In another example, the entire housing 40 may be movable in addition to, or instead of, the reflecting member 38. The reflecting member 38 may include a flat mirror, a convex mirror or both types of mirrors in combination.

In other embodiments, the side view device 12 may include a digital imaging device (not shown). The digital imaging device may, for example, be a digital video camera coupled to an interior video display. In this embodiment, the digital video camera captures images of the view area beside and to the rear of the motor vehicle. Those images are shown to the driver on an interior video display (not shown). In one example, only the digital camera need be moved to alter the field of view of the camera.

In another example, the avoidance system 10 may include a seat sensor 58 coupled to a driver's seat 60. Similar to the position sensor 18, the seat sensor 58 generates a seat signal corresponding to an orientation or position of the driver's seat 60. In this embodiment, the processor 16 is also coupled to the seat sensor 58 and is configured to analyze the seat signal to determine the orientation of the driver seat 60 and, hence, the position of the driver within the motor vehicle 11. The processor 16 then calculates, for example, the approximate position of the driver's eyes within the motor vehicle 11 and uses that information, along with the orientation of the side view device 12, to improve the calculation of the boundaries of the driver's blind spot. This increases the accuracy of the comparison by the processor 16 of the object's locations to the calculated boundaries, reducing the possibility of false positive indications that objects are within the driver's blind spots.

Yet another embodiment of the avoidance system 10 may include a driver height sensor 62. Depending on the particular application, the driver height sensor 62 may be in addition to, or instead of, the seat sensor 58. The height sensor 62 may be placed anywhere within the motor vehicle 11 appropriate for a particular sensor to measure the seated height of the driver and generate a height signal corresponding to the height of the driver. The processor 16 is coupled to the height sensor 62 and is configured to analyze the height signal to, for example, calculate the height of the driver and the approximate position of the driver's eyes. Once the position of the driver's eyes have been calculated a sight line of the driver to the side view device 12 may be calculated allowing further refinement of the blind spot boundaries. This and other calculations mentioned herein are well within the constraints of conventional engineering and need not be detailed further since they will be readily appreciated and derivable by those skilled in the art.

The driver height sensor 62 may be any appropriate sensing device including, for example, an ultrasonic sensor. As noted above, the ultrasonic sensor uses high frequency sound waves reflected off an object to characterize the object. In one example, the ultrasonic sensor may be attached to an interior roof of the motor vehicle 11. The sound waves are thus directed to reflect off of the top of the driver's head. Electronics associated with the ultrasonic sensor measure the time it takes the reflected sound waves to return to the sensor, thereby determining the distance between the ultrasonic sensor and the top of the driver's head. The processor may then use that information, along with other stored information regarding human attributes and the geometry of the motor vehicle, to calculate the height of the driver and the approximate position of the driver's eyes.

In another embodiment, the height sensor 62 may include a visual system. The visual system makes use of, for example, a digital camera positioned to image the head of the driver. Electronics within the height sensor 62, or the processor 16, analyze the image. Based on the location of the height sensor 62 within the motor vehicle 11, the electronics can calculate the height of the driver and a position of the driver's eyes. Depending on the precise location of the height sensor 62, this embodiment may allow the position of the driver's eyes to be directly measured, further increasing the accuracy of the calculated blind spot boundaries.

Another embodiment may further refine the calculation of the blind spot boundaries. This embodiment includes both the seat sensor 58 and the height sensor 62. The processor calculates, for example, the position of the driver's eyes within the motor vehicle 11 using both the seat signal and the height signal to maximize the accuracy of the calculation and further reduce the possibility of false positive indications.

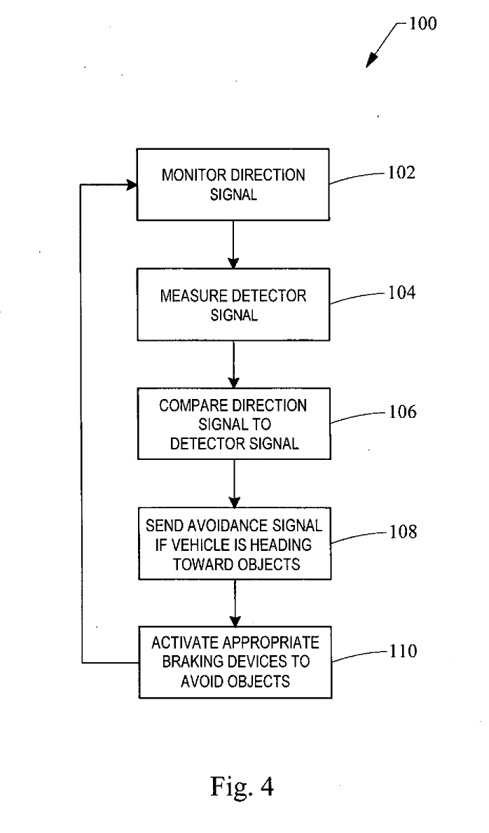

In a further aspect of the present invention, a side collision avoidance method 100, illustrated in the flow chart of FIG. 4, is provided. The method 100 includes monitoring both a direction signal from the direction sensor in box 102 and measuring a detector signal from the external detector in box 104. In box 106, the processor compares the direction signal with the detector signal, the detector signal corresponding to a location of objects outside of the vehicle. In box 108, an avoidance signal is sent to a braking control system if the comparison of box 106 indicates that the motor vehicle is heading toward one of the objects. In box 110, the appropriate braking devices coupled to the braking control system are activated to avoid the objects.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I claim:

1. A motor vehicle side collision avoidance system for avoiding collisions with objects, the system comprising:
at least one direction sensor, the direction sensor generating a direction signal corresponding a direction of motion of the vehicle;
at least one external detector, the external detector generating a detector signal corresponding to a location of objects outside of the vehicle;
a braking control system, the braking control system including at least two independently operable braking devices being coupled to respective wheels of the motor vehicle; and
a processor coupled to the direction sensor, the external detector, and the braking control system, the processor being configured to receive the direction signal and the detector signal and to send an avoidance signal to the braking control system based on the direction signal and detector signal, the braking control system configured to activate at least one of the braking devices based on the avoidance signal to avoid the objects.

2. The system of claim 1 wherein the braking control system includes four independently operable braking devices.

3. The system of claim 1 wherein the at least two braking devices are coupled to wheels on opposing sides of the vehicle.

4. The system of claim 3 wherein the braking control system is configured to direct the vehicle away from objects by operating braking devices on a side of the vehicle opposite from the location of the objects.

5. The system of claim 1 wherein the braking control system is configured to be overridden by additional steering or braking input from a driver of the vehicle.

6. The system of claim 1 further comprising the processor being configured to calculate blind spot boundaries and to compare the blind spot boundaries to the location of objects outside of the vehicle and to send the avoidance signal to the braking control system if an object is located within the blind spot boundaries.

7. The system of claim 6 wherein a blind sport warning indicator is coupled to the processor and configured to provide an indication to a driver if the location of an object corresponds to the calculated blind spot boundaries.

8. The system of claim 7 wherein the warning indicator is at least one of a visual warning device, an audible warning device and a haptic warning device.

9. The system of claim 6 wherein the blind spot boundaries are calculated based upon fixed parameters relating to motor vehicle geometry.

10. The system of claim 6 wherein the blind spot boundaries are calculated based upon variable parameters relating to motor vehicle geometry.

11. The system of claim 10 wherein the variable parameters are supplied to the processor by at least one movable side view device attached to the vehicle and moveable between a first orientation and a second orientation, the side view device being coupled to at least one position sensor adapted to generate a position signal corresponding to an orientation of the side view device, and the processor being coupled to the position sensor to receive the position signal.

12. The system of claim 11 wherein the position sensor is configured to generate a modified position signal upon movement of the side view device from one to the other of the first and second orientations and the processor is configured to calculate altered blind spot boundaries based upon the modified position signal, the processor being further configured to compare the altered blind spot boundaries to the location of objects and to send the avoidance signal to the braking control system if an object is within the altered blind spot boundaries.

13. The system of claim 12 further comprising a seat sensor coupled to at least a driver seat of the motor vehicle, the seat sensor generating a seat signal corresponding to an orientation of the driver seat, and the processor being coupled to the seat sensor and configured to calculate the blind spot boundaries based on both the position signal and the seat signal.

14. The system of claim 12 further comprising a driver height sensor configured to measure a height of the driver and to generate a height signal corresponding to the height of the driver, and the processor being coupled to the height sensor and configured to calculate the blind spot boundaries based on both the position signal and the height signal.

15. The system of claim 12 further comprising a seat sensor coupled to at least a driver seat of the vehicle, the seat sensor generating a seat signal corresponding to an orientation of the driver seat;
a driver height sensor configured to measure a height of a driver of the vehicle, the height sensor generating a height signal corresponding to the height of the driver; and
the processor being coupled to the seat sensor and to the height sensor to receive the seat signal and the height signal, the processor further being configured to calculate the blind spot boundaries based on the position signal, the seat signal, and the height signal.

16. The system of claim 1 wherein the external detector includes at least one of a radar sensor, a ladar sensor, a lidar sensor, an ultrasonic sensor, and an optical sensor.

17. The system of claim 1 wherein the direction sensor includes at least one of an accelerometer, a gyroscope, a steering sensor, a navigation sensor, and a visual sensor.

18. A side collision avoidance method for a motor vehicle, the method comprising:
monitoring a direction signal from a direction sensor, the direction signal corresponding to a direction of motion of the vehicle;
measuring a detector signal from an external detector corresponding to a location of at least one object outside of the vehicle;
comparing the direction signal to the detector signal;
sending an avoidance signal to a braking control system if the comparison indicates the motor vehicle is heading toward the location of the object; and
activating appropriate braking devices coupled to the braking control system to avoid the object.

19. The method of claim 18 further comprising overriding the appropriate braking devices by additional steering or braking input from a driver of the vehicle.

20. The method of claim 18 further comprising determining a blind spot location and sending the avoidance signal to the braking control system only if the location of the object corresponds to the blind spot location.
